(19) United States
(12) Patent Application Publication
(10) Pub. No.: US 2013/0213491 A1
(43) Pub. Date: Aug. 22, 2013

(54) HYDROGEN INFRASTRUCTURE

(71) Applicants: Robert Adler, Gerasdorf (AT); Georg Siebert, Wien (AT); Markus Mayer, Vosendorf (AT)

(72) Inventors: Robert Adler, Gerasdorf (AT); Georg Siebert, Wien (AT); Markus Mayer, Vosendorf (AT)

(21) Appl. No.: 13/696,327

(22) PCT Filed: May 5, 2011
(86) PCT No.: PCT/EP11/02243

§ 371 Date: Dec. 5, 2012

(30) Foreign Application Priority Data
May 12, 2010 (DE) 102010020280.0

(51) Int. Cl. F17D 1/04

(52) U.S. Cl. CPC F17D 1/04
USPC 137/14

(57) ABSTRACT

A method for transporting and distributing gaseous hydrogen is described.

In accordance with the invention, the gaseous hydrogen is transported in a pipeline network (hydrogen pipeline network) that is at least partially integrated into an existing pipeline network (support network), preferably a natural gas pipeline network.

The gaseous hydrogen may be transported as a co- and/or counter-current to the medium flowing in the support network.

The invention relates to a method for transporting and distributing gaseous hydrogen.

Hydrogen is currently primarily produced in decentralized, comparatively large production units, liquefied or compressed and transported by means of appropriate trailers to the location where it is to be used, for example a hydrogen filling station. Further, hydrogen is produced as a by-product in large quantities in many chemical processes. Furthermore, it is envisaged that hydrogen will be produced in decentralized, smaller production units such as, for example, by electrolysis or steam reforming, thereby shortening the distance to be transported or eliminating transport altogether.

The disadvantage of the production methods described above is that the investment costs are comparatively high; in particular, in the case of decentralized production, efficiency is comparatively poor.

Furthermore, hydrogen pipeline networks have also been envisaged in which the hydrogen is transported at various pressures. Such pipeline networks are, however, also highly cost-intensive as regards investment and, moreover, are subject to extensive licensing procedures—for these reasons, this seems unlikely to happen in the near future.

The aim of the present invention is to provide a generic method for transporting and distributing gaseous hydrogen that avoids the disadvantages discussed above.

This aim is achieved by providing a method for transporting and distributing gaseous hydrogen that is characterized in that the gaseous hydrogen is transported in a pipeline network (hydrogen pipeline network) that is at least partially integrated into an existing pipeline network (support network), preferably into a natural gas pipeline network.

Further advantageous embodiments of the method of the invention for transporting and distributing gaseous hydrogen are characterized in that
the gaseous hydrogen is transported as a co- and/or counter-current to the medium flowing in the support network,
after removing it from the hydrogen pipeline network, the hydrogen is compressed to a pressure of 900 bar or is decompressed to a pressure that is below the pressure at which the hydrogen is transported in the hydrogen pipeline network,
the hydrogen is preferably compressed by means of at least one booster compressor,
the transport or distribution of the hydrogen after removal from the hydrogen pipeline network is carried out by means of compressed gas storage vessels,
the transport or distribution of the hydrogen is carried out by means of compressed gas storage vessels at a pressure of between 120 and 900 bar, preferably between 200 and 300 bar; and
the hydrogen is transported at a pressure that is equivalent to that of the support network—this results in low costs for those inline with the network—or at a pressure that differs from that of the support network, preferably a higher pressure—this results in corresponding additional costs for those inline with the network requiring stable pressures.

In accordance with the invention, gaseous hydrogen is now transported in a pipeline network—hereinafter termed a hydrogen pipeline network. In this respect, in accordance with the invention, the hydrogen pipeline network is integrated into an existing pipeline network—hereinafter termed the support network—preferably a natural gas pipeline network.

The term “pipeline network” encompasses all networks that serve to transport and also to distribute gaseous and/or liquid media; in particular for gaseous media, pressurized pipes are used in this regard.

The term “existing pipeline network” also encompasses pipeline networks that will be produced in the future.

Transport by means of a hydrogen pipeline network integrated into an existing pipeline or support network constitutes the most reasonable solution, both energetically and economically, to transport gaseous hydrogen over large distances and to distribute it to customers. In this case, the existing support network is preferably fitted with the hydrogen pipeline network during the course of inspections or maintenance operations.

As already mentioned, hydrogen is currently primarily produced in large industrial plants or as a by-product of chemical processes. Since in many cases they are linked with a natural gas and/or pipeline network—the natural gas transported in it in this case acts as an energy carrier and/or feedstock—, the hydrogen that is produced can be transported away via the existing pipeline networks.

In practice, a separate pipe, preferably a low-diffusion plastic pipe, is introduced into the existing pipe(s) of the support network via which the hydrogen is transported—either as a counter-current or as a co-current to the medium flowing in the support network. Unavoidable leaks or diffusion of hydrogen into the medium are not critical, in particular in the case of natural gas, since this would only result in enriching the natural gas with hydrogen.

The pipe used must be suitable for the prevailing pressure difference. Preferably, the hydrogen pipe system should be secured at a higher pressure than that of the support system employed. If this requirement cannot be satisfied, then the pipe used should also be able to withstand external pressures.

Special pipe systems should be integrated in the case of support networks which transport non-flammable media and/or media based on hydrogen. In these cases, the density requirements for the lines used for hydrogen transport are stricter.

The existing support network or the pipes forming this pipeline network thus act as cladding for the pipes of the hydrogen pipeline network. Construction of the hydrogen pipeline network of the invention should thus be comparatively easy, since no new excavations would be required; inserting a pipe into an existing pipe is known in the art and even in the case of buried pipes can be carried out without expensive excavation work.

The pressure at which the hydrogen is transported within the hydrogen pipeline network corresponds to or exceeds the pressure at which the medium in the support network is flowing. This implementation means that mechanical loads on the pipes feeding the hydrogen are minimized.

If the hydrogen has the same pressure as the natural gas, then the hydrogen can be transported at 5 to 10 times the flow rate. This means that the pipes used for the hydrogen pipeline network do not compromise the flow in the natural gas pipeline network. Only 10% to 20% of the free cross-sectional area of a natural gas pipe is required to transport the equivalent quantity of hydrogen to that of natural gas.

By using a hydrogen pipeline network, gaseous hydrogen can be fed from the production site either directly to the hydrogen consumer or to so-called distribution stations where the hydrogen is removed from the hydrogen pipeline network and compressed or decompressed to the required consumer supply pressure. This compression is preferably carried out by means of a so-called booster compressor; in the case in which the hydrogen is decompressed, known decompression systems are employed.

By using said booster compressor, the hydrogen is compressed to any required hydrogen supply pressure defined by the customer. For hydrogen filling stations, this pressure is between 300 and 900 bar, preferably between 350 and 700 bar, and in the case of distribution of hydrogen through other pressure vessels, it is between 120 and 900 bar, preferably between 200 and 300 bar. The compressed hydrogen can then be transported to the consumers or end customers using an appropriate high pressure trailer. This implementation is of particular application when connections to the delivery zone by the support network are poor or booster compressors are in short supply, for example in an inner city area.

Increasing the pressure using booster compressors as mentioned above from approximately 60 to 900 bar is extremely energy-efficient. Such booster compressors require only half the power of filling compressors, which have a supply pressure of 3 to 5 bar. For the same capacity, booster compressors are only about 1/10th the bulk of a comparable filling compressor. Thus, comparatively inexpensive distribution stations can be constructed at the edge of congested areas.

While hydrogen trailers currently transport the compressed hydrogen at a pressure between 200 and 300 bar, a pressure increase to 1000 bar—such pressures are possible using modern composite bottles—would quadruple the transportation volume of a hydrogen trailer.

If intermediate storage of the hydrogen is required by customers or end users, then so-called medium pressure storage vessels are particularly suitable, in which the gaseous hydrogen is preferably stored at a pressure between 160 and 200 bar.

The method of the invention for transporting and distributing gaseous hydrogen constitutes a comparatively inexpensive and efficient method of transporting gaseous hydrogen over long distances without losses. The disadvantages of the prior art described above are completely overcome with the method of the invention.

1. A method for transporting and distributing gaseous hydrogen, characterized in that the gaseous hydrogen is transported in a pipeline network that is at least partially integrated into an existing pipeline network.

2. The method as claimed in claim 1, characterized in that the gaseous hydrogen is transported as a co- and/or counter-current to the medium flowing in the pipeline network.

3. The method as claimed in claim 1, characterized in that after removing hydrogen from the pipeline network, the hydrogen is compressed to a pressure of 900 bar or is decompressed to a pressure that is below the pressure at which the hydrogen is transported in the pipeline network.

4. The method as claimed in claim 3, characterized in that the hydrogen is compressed by means of at least one booster compressor.

5. The method as claimed in claim 1, characterized in that the transport or distribution of the hydrogen after removal from the hydrogen pipeline network is carried out by means of compressed gas storage vessels.

6. The method as claimed in claim 5, characterized in that the transport or distribution of the hydrogen is carried out by means of compressed gas storage vessels at a pressure of between 120 and 900 bar.

7. The method as claimed in claim 1, characterized in that the hydrogen is transported at a pressure that is equivalent to that of the pipeline network or at a pressure that differs from that of the pipeline network.

8. The method as claimed in claim 1, characterized in that said existing pipeline network is a natural gas pipeline network.

9. The method as claimed in claim 6, characterized in that the pressure is between 200 and 300 bar.

10. The method as claimed in claim 7, characterized in that the pressure of hydrogen is a higher pressure than said pipeline network.
